(19) United States
(12) Patent Application Publication
(10) Pub. No.: US 2016/0198842 A1
(43) Pub. Date: Jul. 14, 2016

(54) MOVABLE TABLE FOR PROJECTOR

(71) Applicant: CJ CGV CO., LTD., Seoul (KR)

(72) Inventors: Su Ryeon KANG, Goyang-si, Gyeonggi-do (KR); WOO CHUL KIM, Incheon (KR); HWAN CHUL KIM, Seoul (KR); Isaac SONG, Seoul (KR)

(21) Appl. No.: 14/897,608

(22) PCT Filed: Aug. 21, 2015
(86) PCT No.: PCT/KR2015/008752

§ 371 Date: Dec. 10, 2015

(30) Foreign Application Priority Data
Sep. 2, 2014 (KR) 10-2014-0116118

(51) Int. Cl. A47B 37/02; A47B 13/08; G03B 21/16; G03B 21/54; G03B 21/14; B60B 33/04; A47B 91/16

(52) U.S. Cl. CPC A47B 37/02; B60B 33/04; A47B 13/081; A47B 91/16; G03B 21/54; G03B 21/145; G03B 21/16

(57) ABSTRACT

The present invention relates to a movable table for a projector including: an upper plate having an inclination adjustment plate disposed on top surface thereof in such a manner as to be adjusted in an angle relative to a horizontal plane; a pair of vertical members extended downward from both ends of one side edge of the upper plate in such a manner as to form the legs of the upper plate; a pair of horizontal members extended horizontally from the underside of the pair of vertical members; caster wheels disposed on free ends of the horizontal members and on the undersides of the vertical members: and levelers located adjacent to the caster wheels disposed on the undersides of the pair of vertical members and each having a stroke in a range of separating the caster wheels from the floor.

### TECHNICAL FIELD

The present invention relates to a movable table for a projector, and more particularly, to a movable table for a projector that is capable of protecting the projector as an electronic optical instrument sensitive to external environment from pollution sources like rainfall, dust and so on even if the projector is used for activities performed on temporary outdoor stages, such as movies, performances, presentations and the like, and that is capable of stably installing the projector even in bad installation conditions.

### BACKGROUND ART

So as to conduct meetings through material screens in companies or organizations or to allow a variety of video materials to be seen to the general public in the places for events such as exhibitions, performances, movies, seminars and the like, a substantially large area screen is needed.

According to current technologies, an LCD display, which is widely adopted in televisions or computer monitors, has a single screen having a maximum 100-inch size, and further, it is very expensive. Du large screen is needed, accordingly, a projector is generally used.

The projector provides a desired screen size through the adjustment of projection distance, and recently, since projectors having FHD (Full HD) image quality have been prevailed at a relatively low price, they are increasingly installed even in general houses or small-sized business places.

The projector is installed in a fixed manner and in a movable manner. In this case, the fixed type installation and the movable type installation have opposite advantages and disadvantages to each other. In case of the fixed type installation, a dedicated bracket is first constructed on a ceiling or wall and a projector is then installed. Accordingly, the fixed type installation can provide stable and optimal setting in installation environment, but it is hard to freely change the installation places. Contrarily, the movable type installation has the opposite advantages to the fixed type installation.

In case of the movable type installation, the projector is first placed on a table or desk having a given height and then connected to a variety of wires like a power line and video/audio input/output lines. If the installation place is changed, however, all settings have to be inconveniently needed again.

So as to solve the inconveniences suffered from the movable type installation of the projector, accordingly, there has been proposed Korean Utility Model Registration No. 20-0276537 entitled “Projection Table”.

The conventional projection table is the table used for installing a presentation projector. In more detail, the projection table easily moves to another place through wheels mounted on the underside thereof, while the projector and a laptop are being placed thereon, and the projection table conveniently supplies power to the projector through a socket connected by a length-adjustable cable, Further, the projection table adjusts height and inclination to allow the projected image to be accurately arranged.

The conventional projection table has some advantages in the movement and installation of the projector, but it can be used only in indoor space. Accordingly, the conventional projection table is not adequate for the use in outdoor environment. As a result, the projector as an electronic optical instrument sensitive to external environment is just exposed to rainfall, dust and so on and thus easily damaged.

Even if the conventional projection table is used indoors, it is installed just on a flat floor, and therefore, there are limitations in installation. That is, it is hard to stably install the projection table under bad floor conditions or in limited external environment.

As activities such as movies, performances, new product launch events, presentations and the like conducted on temporary outdoor stages have been increased, recently, there is a definite need for development of a new device capable of installing a projector in a simple and efficient manner under bad conditions of the temporary outdoor stages.

### DISCLOSURE OF INVENTION

### Technical Problem

Accordingly, the present invention has been made in view of the above-mentioned problems occurring in the prior art, and it is an object of the present invention to provide a movable table for a projector that is capable of installing the projector in a stable and convenient manner on indoor places as well as temporary outdoor places under bad installation conditions.

It is another object of the present invention to provide a movable table for a projector that is capable of easily installing the projector even on places like seats, stairs, and inclined surfaces so as to allow both side wall surfaces of a cinema space to be utilized as screens, thus conducting multiple projection.

### Solution to Problem

To accomplish the above-mentioned objects, according to a first aspect of the present invention, there is provided a movable table for a projector including: an upper plate having an inclination adjustment plate disposed on top surface thereof in such a manner as to be adjusted in an angle relative to a horizontal plane; a pair of vertical members extended downward from both ends of one side edge of the upper plate in such a manner as to form the legs of the upper plate; a pair of horizontal members extended horizontally from the underside of the pair of vertical members; caster wheels disposed on free ends of the horizontal members and on the undersides of the vertical members; and levelers located adjacent to the caster wheels disposed on the undersides of the pair of vertical members and each having a stroke in a range of separating the caster wheels from the floor.

To accomplish the above-mentioned objects, according to a second aspect of the present invention, there is provided a movable table for a projector including: an upper plate having an inclination adjustment plate disposed on top surface thereof in such a manner as to be adjusted in an angle relative to a horizontal plane; and a tripod mounted on the underside of the upper plate and having three retractable/extendible support legs.

According to the present invention, preferably, the stroke of each leveler has a given size corresponding to the height of a stair on which the movable table is installed.

According to the present invention, preferably, the movable table for a projector further includes a cover having a shape of a box-like body forming a space in which the projector is accommodated, while the coupled surfaces with the upper plate are being sealed, and the cover includes an opening portion formed on one side surface corresponding to a horizontal rotary surface of the inclination adjustment plate to allow projection light from the projector to be passed therethrough and an inlet and exhaust duct adapted to exchange the air in the accommodating space with outside air.

According to the present invention, preferably, the cover further includes an electronic fan disposed on at least a portion of the inlet and exhaust duct.

According to the present invention, preferably, the opening portion is formed on a slide member slidingly movable along the side surface of the cover, and the slide member is a flexible member slidingly movable along at least two neighboring side surfaces of the cover.

According to the present invention, preferably, the movable table further includes a first level and a second level perpendicular to each other on the horizon plane to indicate the horizontal state of the upper plate, the first level and the second level being disposed on the upper plate.

According to the present invention, preferably, the levelers are electronic levelers having gyroscope sensors adapted to sense and output the inclination of the upper plate and a controller adapted to control up and down driving of the electronic levelers by receiving the inclination sensed by the gyroscope sensors and to allow the upper plate to be in a horizontal state.

According to the present invention, preferably, the horizontal members cross each other to have a shape of X in such a manner as to be extended horizontally from the vertical members, and the movable table further includes a reinforcing member adapted to connect the lower ends of the horizontal members to each other.

According to the present invention, preferably, on at least any one of the reinforcing member, the vertical members, and the horizontal members is disposed a connector for a power line and electric signal lines extendedly embedded into the vertical members to electrically connect the power line and the electric signal lines to the projector mounted on the inclination adjustment plate.

According to the present invention, preferably, the connector has an openable sealing cover disposed on an entrance thereof.

According to the present invention, preferably, the adjusted angle of the inclination adjustment plate with respect to a rotary shaft is selectively maintained and released by a ratchet mechanism, and otherwise, the angle of the inclination adjustment plate is adjusted by an electromotive adjusting mechanism.

### Advantageous Effects of Invention

According to the present invention, the movable table for a projector can prevent the projector as an electronic optical instrument sensitive to external environment from being exposed to pollution sources like rainfall, dust and so on, can stably install the projector even under bad conditions of the outdoor floor, and can be freely moved like a set of movable equipment, in the state where the projector is installed thereon.

### BRIEF DESCRIPTION OF DRAWINGS

FIG. 1 is a separate perspective view showing the whole configuration of a movable table for a projector according to a first embodiment of the present invention.

FIG. 2 is a perspective view showing the assembled state of the movable table for a projector according to the first embodiment of the present invention.

FIG. 3 is a perspective view showing a cover of the movable table for a projector according to the first embodiment of the present invention.

FIG. 4 is a side view showing a connector for a power line and electric signal lines embedded into the movable table for a projector according to the first embodiment of the present invention.

FIG. 5 is a side sectional view showing the inclination adjustment structure of an inclination adjustment plate of the movable table for a projector according to the first embodiment of the present invention.

FIG. 6 is a side sectional view showing the inclination adjustment structure of another inclination adjustment plate of the movable table for a projector according to the first embodiment of the present invention.

FIG. 7 is aside view showing the state where the movable table for a projector according to the first embodiment of the present invention is installed on stairs in a cinema on which a seat is disposed.

FIG. 8 is a side view showing electric levelers for automatic type horizontal adjustment adopted for the installation of the movable table for a projector according to the first embodiment of the present invention on the stairs in the cinema.

FIG. 9 is a perspective view showing the whole configuration of a movable table for a projector according to a second embodiment of the present invention.

### MODE FOR THE INVENTION

Hereinafter, an explanation on a movable table for a projector according to the present invention will be in detail given with reference to the attached drawings.

Before the present invention is disclosed and described, it is to be understood that the terminology used herein is for the purpose of describing particular embodiments only and is not intended to be limiting. Therefore, the terminology used herein should be interpreted as the meaning and concept confirming the technological scope of the present invention so as to explain the present invention in the best way. In the description, the thicknesses of the lines or the sizes of the components shown in the drawing may be magnified for the clarity and convenience of the description.

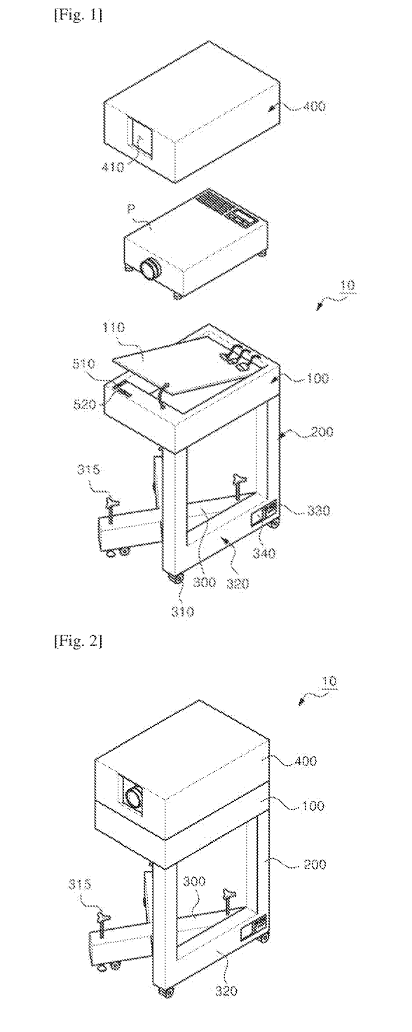

Referring to FIGS. 1 and 2, the whole configuration of a movable table for a projector according to a first embodiment of the present invention will be described.

As shown, a movable table 10 for a projector according to a first embodiment of the present invention largely includes an upper plate 100, a pair of vertical members 200 connected to the upper plate 100, and a pair of horizontal members 300 connected to the pair of vertical members 200.

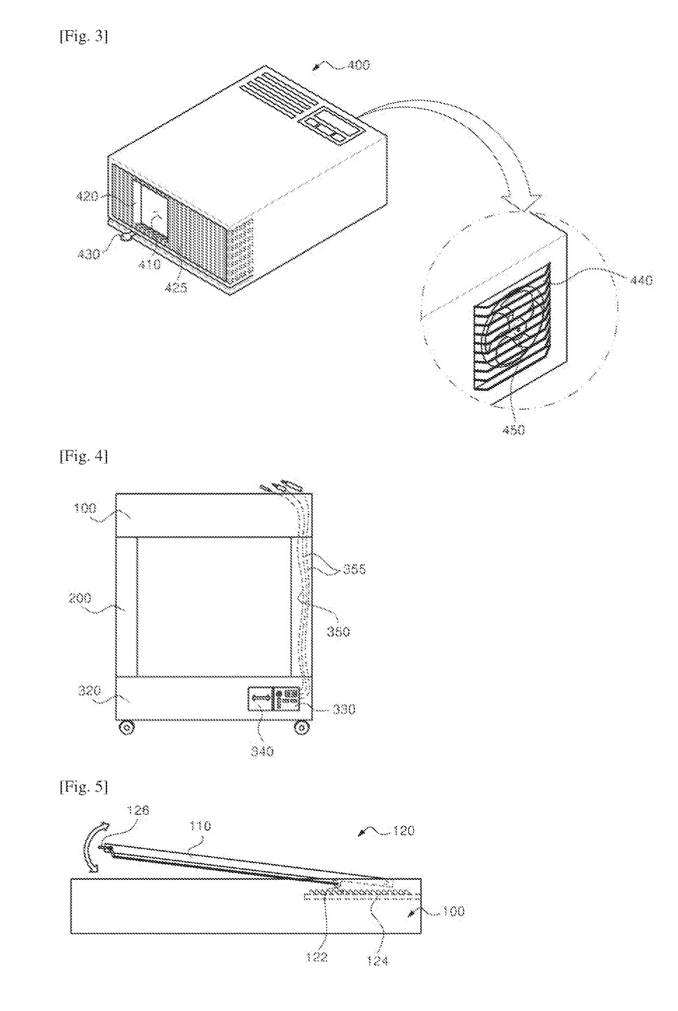

The upper plate 100 has an inclination adjustment plate 110 disposed on top surface thereof in such a manner as to be adjusted in an angle relative to a horizontal plane, and a projector P is mounted on the inclination adjustment plate 110. An explanation on the structure of adjusting the angle of the inclination adjustment plate 110 will be given later with reference to FIGS. 5 and 6.

The pair of vertical members 200 and the pair of horizontal members 300 serve to support the upper plate 100 of the movable table 10. The pair of vertical members 200 is extended downward from both ends of one side edge of the upper plate 100 to form the legs for the upper plate 100, and the pair of horizontal members 300 is extended horizontally from the underside of the pair of vertical members 200.

The pair of horizontal members 300 has a given size having a stable supporting area capable of preventing the movable table 10 from easily falling down due to the load of the projector P mounted on the upper plate 100 or light external impacts, and in this case, the pair of horizontal members 300 has a size corresponding to the upper plate 100.

According to the first embodiment of the present invention, the horizontal members 300 cross each other to have a shape of X in such a manner as to be extended horizontally from the vertical members 200, thus providing uniform supporting forces over every direction. Further, a reinforcing member 320 is provided to connect the lower ends of the horizontal members 300 to each other, thus ensuring a more rigid supporting structure.

Further, caster wheels 310 are disposed on free ends of the horizontal members 300 and on the undersides of the vertical members 200, thus ensuring the movability of the movable table 10 for the projector, and so as to prevent the movable table 10 from moving unintentionally after moves to a desired position, length-adjustable levelers 315 are located adjacent to the caster wheels 310.

According to the first embodiment of the present invention, the caster wheels 310 have the shapes of generally disc type wheels, and further, they may have ball type rolling wheels freely rotatable, without having any fixed rotary shaft. Otherwise, they may have other type wheels.

The levelers 315 adjust lengths as the legs screw-coupled thereto are moved up and down through rotary manipulations, and at this time, the stroke (up and down moving distance) of each leveler 315 has a given size in a range of separating the caster wheel 310 from the floor.

Furthermore, the stroke of each leveler 315 may have a given size corresponding to the height of one stair formed at a center of a cinema space sufficiently distant from both side wall surfaces, so that the movable table 10 for a projector according to the present invention can be installed on the stair to conduct multiple projection.

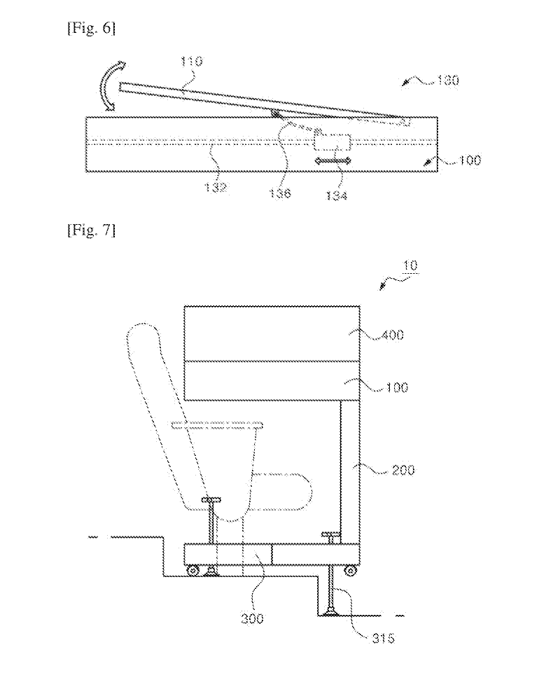

FIG. 7 is aside view showing the state where the movable table for a projector according to the first embodiment of the present invention is installed in a cinema having a stair structure on which a seat is disposed.

As shown, the vertical members 200 of the movable table 10 according to the present invention are extended downward from both ends of one side edge of the upper plate 100 to form the legs for the upper plate 100, and there are no legs on the other side edge of the upper plate 100, so that the horizontal members 300 are deeply inserted into the space under the seat, thus making it possible to install the movable table 10 on the stair where the seat is disposed.

If the width of the movable table 10 is greater than that of the stair to cause the supporting area of the movable table 10 to become small, moreover, the levelers 315 are moved down longer to the down stair, thus providing stable installation on the stairs. Accordingly, as shown in FIG. 7, the levelers 315 are desirably located adjacent to the caster wheels 310 disposed on the undersides of the vertical members 200.

Further, the movable table 10 for a projector according to the present invention includes a cover 400 adapted to cover the upper plate 100.

The cover 400 is a box-like body that forms a space in which the projector P is accommodated, while the coupled surfaces with the upper plate 100 are being sealed. That is, the cover 400 has a shape of an entirely closed box except one surface coupled to the upper plate 100, thus preventing an unnecessary light source (leakage light source) emitted from the projector P disposed at the interior thereof from being exposed to customers and also protecting the projector P from external impacts. Particularly, if the movable table 10 is used in outdoor environment, the cover 400 has IP 65-rated waterproof and anti-fouling functions.

Further, the cover 400 has an opening portion 410 formed on one side surface corresponding to a horizontal rotary surface (the edge surface whose inclination relative to the ground is adjusted up and down) of the inclination adjustment plate 110 disposed on the upper plate 100, thus allowing the projection light from the projector P to be passed therethrough.

FIG. 3 is a perspective view showing the cover of the movable table for a projector according to the first embodiment of the present invention. In this case, the opening portion 410 of the cover 400 may be changed freely to desired positions, and while the projector P is being not used, further, the opening portion 410 is completely closed to basically prevent foreign matters from being invaded from the outside, thus improving the waterproof and anti-fouling functions.

That is, a projection lens may be disposed at different positions, for example, at center, at left side, and at right side, according to the projectors, and therefore, there is a need to adjust the position of the opening portion 410 according to the position of the projection lens of the projector P. In addition, the opening portion 410 is selectively closed while the projector P is being not used, thus protecting the projector P stably.

As shown in FIG. 3, the opening portion 410 is formed on a slide member 420 slidingly movable along the side surface of the cover 400, and when a handle 430 connected to the slide member 420 is moved to left and right sides, the position of the opening portion 410 is changed. In this case, the slide member 420 is fitted to grooves formed along the edge of the cover 400 in such a manner as to be slidingly moved along the grooves. At this time, the slide member 420 forms a portion of one side surface (the side surface in the projection direction of the projector) of the cover 400.

Furthermore, the slide member 420 may be slidingly movable along at least two neighboring side surfaces of the cover 400, thus having a movable range over at least two neighboring side surfaces of the cover 400, and in this case, the other surfaces of the cover 400 except the surfaces of the cover 400 with which the projection lens of the. projector P faces are closed to prevent the slide member 420 from being exposed to the outside, thus allowing the opening portion 410 to be hidden behind the side surfaces. Accordingly, the opening portion 410 can be hidden, while being not exposed to the outside, and in this case, the slide member 420 should be made of a flexible material because it is moved along the two neighboring side surfaces of the cover 400 bent and connected to each other.

Otherwise, the flexible slide member 420 may be made of a hard material, while having a plurality of equally spaced slots 425 formed vertically as shown in FIG. 3, so that it can be flexibly bent.

On the other hand, the projector P makes use of a lamp having a high luminous intensity as a light source so as to project a vivid large area image, and the light source generates a lot of heat therefrom. If the accommodating space inside the cover 400 is completely closed, accordingly, the internal temperature of the cover 400 becomes too high, thus giving bad influences to the operation and life span of the projector P as an electronic optical instrument. Therefore, an inlet and exhaust duct 440 is desirably formed on the side surface (in most cases, the rear surface relative to the opening portion) except the surface on which the opening portion 410 is formed so as to exchange the air in the accommodating space with outside air.

Both of natural convection type cooling through the inlet and exhaust duct 440 open to the outside air and forced convection type cooling through an electronic fan 450 disposed on at least a portion of the inlet and exhaust duct 440 are conducted, so that the natural convection type cooling and the forced convection type cooling may be all or selectively introduced.

Furthermore, some additional means may be disposed to provide the conveniences in use of the movable table 10 for a projector according to the present invention.

First, levels are disposed to allow the movable table 10, that is, the upper plate 100 on which the projector P is located to be in a horizontal state. Through the checking of the horizontal state of the movable table 10, it can be checked whether the movable table 10 is stably installed or not, and at the same time, the projected image on a screen is adjusted to avoid up and down tilting thereof.

So as to indicate the horizontal states of the movable table 10 and the upper plate 100, according to the present invention, a first level 510 and a second level 520 are disposed on the upper plate 100 in such a manner as to be perpendicular to each other on the horizontal plane, thus allowing the horizontal states to be easily checked out by the naked eye (see FIG. 1). Under the condition where the first level 510 and the second level 520 can check the horizontal states of the movable table 10 and the upper plate 100, of course, they may be disposed on other positions such as the vertical members 200, the horizontal members 300 and so on, in addition to the upper plate 100.

Furthermore, a structure for automatically adjusting the horizontal state of the upper plate 100 may be adopted. The first level 510 and the second level 520 adopt an analog system wherein the horizontal state of the upper plate 100 is adjusted as the levelers 315 are adjusted through manual manipulation with respect to the position of an air bubble observed by the naked eye. Instead of the first level 510 and the second level 520, gyroscope sensors 530 are disposed to measure the inclinations of X, and Z axes, and through the inclination information on the respective axes outputted from the gyroscope sensors 530, the horizontal state of the upper plate 100 can be automatically adjusted and maintained.

At this time, the levelers 315 are replaced with electric levelers 315′ whose driving is automatically controlled according to the calculation results of a controller 317 to which the information outputted from the gyroscope sensors 530 is received. In more detail, the up and down driving of the electric levelers 315′ is feed-back controlled by the controller 317 to allow the upper plate 100 to be in a horizontal state on the basis of the input values of the inclinations of the X, Y and Z axes measured through the gyroscope sensors 530, thus conducting automatic horizontal control.

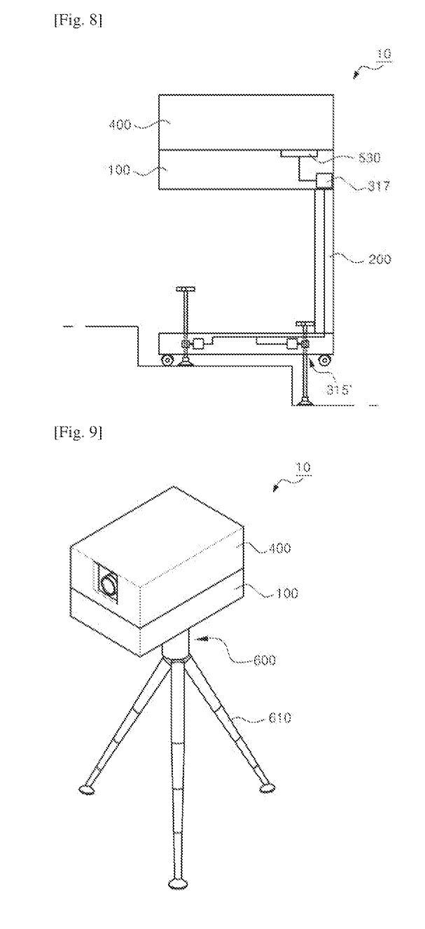

The electric levelers 315′ may be employed in various known technologies, and for example, they are motor driven levelers that are automatically controllable or hydraulic driven levelers. The electric leveler 315′ with worm gears, as examples of the motor driven levelers, are shown in FIG. 8. The worm gear type electric levelers 315′ are moved up and down only by means of the forward and reverse rotation of the worm gears, without being rotated, and accordingly, no brake mechanism is needed, thus advantageously making the electric levelers 315′ simple in structure.

Additionally, a connector 330 for a power line 350 and electric signal lines 355 electrically connected to the projector P is disposed on at least any one of the reinforcing member 320, the vertical members 200, and the horizontal members 300, and the configuration of the connector 330 is shown in FIG. 4. The lines necessary for inputting power and electric signals (video/audio signals) required to drive the projector P are previously prepared on the movable table 10, so that they can be easily connected to the projector P mounted on the upper table 100, and further, the projector P connected to the lines and the movable table 10 are easily connected to outside lines at the position after moved, thus providing independence, conveniences, and stability in the site wiring.

The power line 350 and the electric signal lines 355 are desirably extendedly embedded in the vertical member 200 to improve the outer appearance of the movable table 10 and protect them from the external environment, and further, a sealing cover 340 is disposed on an entrance of the connector 330 to conduct the waterproofing and anti-fouling for the connector 330.

On the other hand, FIGS. 5 and 6 show the structures wherein the inclination of the inclination adjustment plate 110 is adjusted, and the angle adjustment of the inclination adjustment plate 110 is conducted to adjust up and down projection angles of the projector P to the screen. For example, FIG. 5 shows manual adjustment using a ratchet mechanism, and FIG. 6 shows electromotive adjustment using a motor.

First, an explanation on a manual adjustment mechanism 120, as shown in FIG. 5, for adjusting the angle of the inclination adjustment plate 110 will be given. Pawls 122 are elastically supported against both sides of the underside of the inclination adjustment plate 110, and a ratchet 124 is supportedly disposed on the upper plate 100 in such a manner as to correspond to the inclination adjustment plate 110 under the inclination adjustment plate 110.

If a force is applied to move the inclination adjustment plate 110 down, the pawls 122 are not rotated, but they are rotated by the force applied in the opposite direction to the force applied to move the inclination adjustment plate 110 down. Accordingly, if the inclination adjustment plate 110 is taken to move up, the pawls 122 are freely moved along the ratchet 124, and at this time, if the force applied to the inclination adjustment plate 110 is released, the pawls 122 are fixed to a set angle by means of its own weight and the load of the projector P.

Further, a ratchet releasing mechanism 126 is disposed on the inclination adjustment plate 110, so that if the ratchet releasing mechanism 126 is pressed or taken to pull, the pawls 122 are rotated and come into contact with the underside of the inclination adjustment plate 110 to allow the inclination adjustment plate 110 to be freely moved down.

Next, an explanation on an electromotive angle adjustment mechanism 130 as shown in FIG. 6 will be given. The electromotive angle adjustment mechanism 130 includes guide rails 132 formed on the upper plate 100, linear motors 134 conducting forward and backward linear movements along the guide rails 132, and rotary arms 136 hinge-connected rotatably to the underside of the inclination adjustment plate 110 on both ends thereof. As the distances of the hinged points between the rotary arms 136 and the underside of the inclination adjustment plate 110 are changed in accordance with the forward and backward movements of the linear motors 134, the rotary arms 136 are moved up and down to adjust the angle of the inclination adjustment plate 110.

On the other hand, FIG. 9 is a perspective view showing the whole configuration of a movable table for a projector according to a second embodiment of the present invention.

According to a second embodiment of the present invention, the upper plate 100, the manual/electromotive angle adjustment mechanisms 120 and 130, and the cover 400 are the same as those in the first embodiment of the present invention as shown in FIGS. 1 to 8, except that the structure of supporting the underside of the upper plate 100 is different from that in the first embodiment of the present invention.

As shown in FIG. 9, a movable table 10 for a projector according to the second embodiment of the present invention includes a tripod 600 mounted on the underside of the upper plate 100 and having three retractable/extendible support legs 610.

In more detail, the support legs 610 of the tripod 600 are individually extendible telescopic legs, so that even though the floor surface is not even or if there are stairs or inclinations, the heights of the support legs 610 are adjusted appropriately according to the state of the floor to support the upper plate 100 at three points in a balancing state. In this case, the first level 510 and the second level 520 are of course adopted as auxiliary mechanisms for adjusting the horizontal state of the upper plate 100.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A movable table for a projector comprising:
an upper plate having an inclination adjustment plate disposed on top surface thereof in such a manner as to be adjusted in an angle relative to a horizontal plane;
a pair of vertical members extended downward from both ends of one side edge of the upper plate in such a manner as to form the legs of the upper plate;
a pair of horizontal members extended horizontally from the underside of the pair of vertical members;
caster wheels disposed on free ends of the horizontal members and on the undersides of the vertical members; and
levelers located adjacent to the caster wheels disposed on the undersides of the pair of vertical members and each having a stroke in a range of separating the caster wheels from the floor.

2. A movable table for a projector comprising:
an upper plate having an inclination adjustment plate disposed on top surface thereof in such a manner as to be adjusted in an angle relative to a horizontal plane; and
a tripod mounted on the underside of the upper plate and having three retractable/extendible support legs.

3. The movable table for a projector according to claim 1, wherein the stroke of each leveler has a given size corresponding to the height of a stair on which the movable table is installed.

4. The movable table for a projector according to claim 1, further comprising a cover having a shape of a box-like body forming a space in which the projector is accommodated, while the coupled surfaces with the upper plate are being sealed, and the cover comprises an opening portion formed on one side surface corresponding to a horizontal rotary surface of the inclination adjustment plate to allow projection light from the projector to be passed therethrough and an inlet and exhaust duct adapted to exchange the air in the accommodating space with outside air.

5. The movable table for a projector according to claim 4, wherein the cover further comprises an electronic fan disposed on at least a portion of the inlet and exhaust duct.

6. The movable table for a projector according to claim 4, wherein the opening portion is formed on a slide member slidingly movable along the side surface of the cover.

7. The movable table for a projector according to claim 6, wherein the slide member is a flexible member slidingly movable along at least two neighboring side surfaces of the cover.

8. The movable table for a projector according to claim 1, further comprising a first level and a second level perpendicular to each other on the horizontal plane to indicate the horizontal state of the upper plate.

9. The movable table for a projector according to claim 8, wherein the first level and the second level are disposed on the upper plate.

10. The movable table for a projector according to claim 1, wherein the levelers are electronic levelers having gyroscope sensors adapted to sense and output the inclination of the upper plate and a controller adapted to control up and down driving of the electronic levelers by receiving the inclination sensed by the gyroscope sensors and to allow the upper plate to be in a horizontal state.

11. The movable table for a projector according to claim 1, wherein the horizontal members cross each other to have a shape of X in such a manner as to be extended horizontally from the vertical members.

12. The movable table for a projector according to claim 1, further comprising a reinforcing member adapted to connect the lower ends of the horizontal members to each other.

13. The movable table for a projector according to claim 12, wherein on at least any one of the reinforcing member, the vertical members, and the horizontal members is disposed a connector for a power line and electric signal lines extendedly embedded into the vertical members to electrically connect the power line and the electric signal lines to the projector mounted on the inclination adjustment plate.

14. The movable table for a projector according to claim 13, wherein the connector has an openable sealing cover disposed on an entrance thereof.

15. The movable table for a projector according to claim 1, wherein the adjusted angle of the inclination adjustment plate with respect to a rotary shaft is selectively maintained and released by a ratchet mechanism.

16. The movable table for a projector according to claim 1, wherein the angle of the inclination adjustment plate is adjusted by an electromotive adjusting mechanism.
